(19) United States
(12) Patent Application Publication
(10) Pub. No.: US 2024/0092097 A1
(43) Pub. Date: Mar. 21, 2024

(54) RECORDING METHOD AND RECORDING SYSTEM

(71) Applicant: Konica Minolta, Inc., Tokyo (JP)

(72) Inventor: Masashi IKEDA, Tokyo (JP)

(21) Appl. No.: 18/460,164

(22) Filed: Sep. 1, 2023

(30) Foreign Application Priority Data
Sep. 7, 2022 (JP) 2022-141827

(51) Int. Cl. B41J 11/00; B41J 2/21

(52) U.S. Cl. CPC B41J 11/007; B41J 2/2107

(57) ABSTRACT

A recording method includes: conveying a recording medium; and performing recording by ejecting droplets of an inkjet ink onto the recording medium while conveying the recording medium, wherein, a conveyance speed of the recording medium is 500 mm/s or more, the inkjet ink contains at least water and a pigment, the content of the pigment is 5% by mass or more with respect to a total amount of the inkjet ink, and one droplet of the inkjet ink has a volume of 3 pL or less.

### CROSS-REFERENCE TO RELATED APPLICATIONS

The entire disclosure of Japanese Patent Application No. 2022-141827, filed on Sep. 7, 2022, including description, claims, drawings and abstract is incorporated herein by reference.

### BACKGROUND

### Technical Field

The present invention relates to a recording method and a recording system. The present invention relates to a recording method which improves drying efficiency of a water-based ink particularly in high-speed conveyance, prevents sheet deformation, ink penetrating, and color bleeding, and is excellent in color gamut and graininess, and the like.

### Description of Related Art

Inkjet recording methods using water-based ink are widely used. In an inkjet printer used in the inkjet recording method, a scanning type or single type inkjet head is used.

In particular, in the case of a single-pass inkjet printer, recording is performed at a very high recording speed (image forming speed). Therefore, since the water-based ink contains a large amount of water, it is necessary to dry the ink in a short time.

Therefore, for example, a technology described in Japanese Patent No. 6558481 is disclosed for drying of water. The technology includes a first dryer and a second dryer. The first dryer is a thermal conduction type or convection type dryer that evaporates 50% to 85% by mass of the ink with respect to the recording medium to which the ink is jetted from the recording head. The second dryer is a convection type in which the recording medium dried by the first dryer is dried on the downstream side in the feeding direction of the recording medium with respect to the medium support portion.

In addition, in the technique described in Japanese Patent No. 6619452, the surface pre-heater that heats at least a surface of a recording medium is provided upstream of an inkjet head in conveying.

However, the dryer and the surface pre-heater described in the aforementioned Japanese Patent Nos. 6558481 and 6619452 are large in size, and there is a problem that power costs required for drying are high.

Furthermore, due to a large amount of water contained, there are also problems that image quality changes depending on the sheet type and that sheet deformation such as curling and cockling tends to occur. As described above, in the single-pass inkjet recording method, the drying properties of the water-based ink has been a problem.

Furthermore, there are demands for expanding the color gamut and forming an image with excellent graininess.

### SUMMARY

The present invention has been made in view of the above problems and circumstances. An object of the present invention is to provide a recording method and a recording system which improve drying efficiency of a water-based ink in high-speed conveyance, prevent sheet deformation, ink penetrating, and color bleeding, and are excellent in color gamut and graininess.

In order to solve the above-described problems, the present inventors have found the following importance in the process of examining the cause or the like of the above-described problems. The present inventors set the content of the pigment in the inkjet ink to a high concentration of 5% by mass or more, and set the size of one liquid droplet of the inkjet ink to a small droplet which is 3 pL or less. Thus, it is possible to provide a recording method which improves drying efficiency of the water-based ink in high-speed conveyance, prevents sheet deformation, ink penetrating, and color bleed, and is excellent in color gamut and graininess.

That is, the aforementioned problem according to the present invention is solved by the following means.

A recording method including: conveying a recording medium; and performing recording by ejecting droplets of an inkjet ink onto the recording medium while conveying the recording medium, wherein, a conveyance speed of the recording medium is 500 mm/s or more, the inkjet ink contains at least water and a pigment, the content of the pigment is 5% by mass or more with respect to a total amount of the inkjet ink, and one droplet of the inkjet ink has a volume of 3 pL or less.

A recording system including: a conveyor that conveys a recording medium; and an inkjet ink ejector that performs recording by ejecting a droplet of an inkjet ink onto the recording medium while conveying the recording medium, wherein, a conveyance speed of the recording medium is 500 mm/s or more, the inkjet ink contains at least water and a pigment, the content of the pigment is 5% by mass or more with respect to a total amount of the inkjet ink, and one droplet of the inkjet ink has a volume of 3 pL or less.

### BRIEF DESCRIPTION OF THE DRAWINGS

The advantages and features provided by one or more embodiments of the invention will become more understood from the detailed description given hereinafter and the appended drawings which are given by way of illustration only, and thus are not intended as a definition of the limits of the present invention, and wherein:

FIG. 1 is a schematic diagram showing an inkjet recording apparatus;

FIG. 2 is a bottom view of the head unit;

FIG. 3A is a perspective view of an inkjet head;

FIG. 3B is a cross-sectional view of an inkjet head;

FIG. 4 is an exploded perspective view of the inkjet head;

FIG. 5 is an exploded perspective view of a head chip;

FIG. 6A is a plan view of a pressure chamber board;

FIG. 6B is a bottom view of the pressure chamber board;

FIG. 7A is a plan view of a channel board;

FIG. 7B is a bottom view of the channel board;

FIG. 8 is a plan view of a nozzle board;

FIG. 9A is a cross-sectional view of a head chip taken along line IXA-IXA;

FIG. 9B is a cross-sectional view of the head chip taken along line IXB-IXB;

FIG. 10A is a cross-sectional view of the head chip taken along XA-XB;

FIG. 10B is a cross-sectional view of the head chip taken along XA-XB; and

FIG. 11 is a schematic diagram illustrating an ink circulation system.

### DETAILED DESCRIPTION

Hereinafter, one or more embodiments of the present invention will be described with reference to the drawings. However, the scope of the invention is not limited to the disclosed embodiments.

The recording method of the present invention is a recording method for performing recording by ejecting droplets of an inkjet ink onto recording media while conveying the recording media, wherein the conveyance speed of the recording medium is 500 mm/s or more, the inkjet ink contains at least water and pigments, the content of the pigments is 5% by mass or more with respect to the total amount of the ink, and the volume of one droplet of the inkjet ink is 3 pL or less.

This feature is a technical feature common to or corresponding to each of the following embodiments.

As an embodiment of the present invention, it is preferable that a dot enlargement rate of one liquid droplet of the inkjet ink landed on the recording medium is within a range of 2.2 to 3.5 times, from the viewpoint of further improving drying efficiency by forming a thin film. Furthermore, it is preferable in that the color gamut is expanded and the color developability becomes more satisfactory.

It is preferable that the liquid droplets are ejected while the inkjet ink is circulated by an ink circulation means, in terms of achieving favorable ink ejection stability.

It is preferable that the inkjet ink further contains an organic solvent and the content of the organic solvent is such that the total content of the organic solvent is within a range of 0.1 to 25% by mass with respect to the total amount of the inkjet ink from the viewpoint of quick-drying properties.

Further, the content of the water is preferably 40% by mass or more with respect to the total amount of the inkjet ink from the viewpoint of quick-drying properties.

Preferably, one liquid droplet of the inkjet ink has a volume within a range of 1 to 2pL from the viewpoint of quick drying with small droplets.

From the viewpoint of high-speed conveyance, it is preferable that the recording medium conveyance speed be 1000 mm/s or more.

It is preferable that the minimum dot diameter of one liquid droplet of the inkjet ink having landed on the recording medium is 45 μm or less, since the graininess of an obtained image becomes satisfactory even with an ink having a high pigment concentration.

The drying time until 80% by mass or more of the inkjet ink landed on the recording medium is evaporated is preferably 1 second or less from the viewpoint of prevention of sheet deformation.

It is preferable to convey the recording medium by a flat sheet method, in that it is possible to prevent the recording medium from being deformed, for example, corrugated.

According to an aspect of the present invention, there is provided a recording system for performing recording by ejecting liquid droplets of an inkjet ink onto a recording medium while conveying the recording medium, in which a conveyance speed of the recording medium is 500 mm/s or more, the inkjet ink contains at least water and a pigment, a content of the pigment is 5% by mass or more with respect to a total amount of the inkjet ink, and a volume of one liquid droplet of the inkjet ink is 3 pL or less.

According to the recording system of the embodiment of the present invention, it is possible to improve the drying efficiency of water-based ink in high-speed conveyance and expand the color gamut.

Hereinafter, the present invention, constituent elements thereof, and modes and aspects for carrying out the present invention will be described. In the present application, “-” or “to” is used to mean that numerical values described before and after “-” or “to” are included as a lower limit value and an upper limit value.

### [Recording Method of Invention]

The recording method of the present invention is a recording method for performing recording by ejecting droplets of an inkjet ink onto recording media while conveying the recording media, wherein the conveyance speed of the recording medium is 500 mm/s or more, the inkjet ink contains at least water and pigments, the content of the pigments is 5% by mass or more with respect to the total amount of the ink, and the volume of one droplet of the inkjet ink is 3 pL or less.

Such a recording method of the present invention preferably has a step of ejecting an inkjet ink onto a recording medium and a step of drying the inkjet ink ejected onto the recording medium (drying step). In addition, it is more preferable to have a step of applying a pre-coat liquid onto the recording medium in advance before ejecting the inkjet ink (pre-coat liquid application step).

The inkjet recording method of the present invention is performed by high-speed conveyance in which the conveyance speed of the recording medium is 500 mm/s or more. That is, the inkjet recording method is a recording method using an inkjet recording apparatus (inkjet printer) equipped with a single-pass inkjet head as described later.

Preferably, the conveyance speed of the recording medium is 500-2500 mm/s, and within a range of 1000-2000 mm/s. Furthermore, in the inkjet recording method of the present invention, the recording medium is preferably conveyed by a flat sheet method.

In addition, in the inkjet ink used in the inkjet recording method of the present invention, the content of the pigment is 5% by mass or more with respect to the total amount of the ink, and it is preferable that the content is in a range of 5 to 15% by mass from the viewpoint of drying properties since the ink has a high pigment concentration.

In addition, the volume of one liquid droplet of the inkjet ink is equal to or smaller than 3 pL, and is preferably within a range of 1 to 2 pL from the viewpoint of fast drying properties with small liquid droplets.

The volume of one droplet of the inkjet ink is the amount of one droplet ejected from one nozzle, and is calculated by the following method.
droplet amount=measured weight/(number of nozzles×number of ejections×ink specific gravity)

To print an image by selecting an arbitrary number of nozzles and an arbitrary number of discharge. After printing, the weight was measured by weighing with a balance immediately without performing a drying step. Then, a value obtained by subtracting the weight of the sheet before printing from the measured value was defined as the “measured weight”.

For example, 1000 nozzles at the center of the Samba G3L are selected, 5000 ejections are ejected from each nozzle, and a 1000 pixel×5000 pixel image is printed. In this case, liquid droplet amount=measured weight/(1000 ×5000×specific gravity of ink).

In addition, in order to make the volume of one liquid droplet equal to or smaller than 3 pL, for example, by setting a pulse width to form an arbitrary waveform, it is possible to perform adjustment by controlling the amount of ink droplets ejected from the pressure chamber and the number of ink droplets. It is preferable that the ink adopt, for example, a driving method of ldpd to a plurality of dpd.

Furthermore, the dot enlargement rate of one droplet of the inkjet ink that has landed on the recording medium is preferably within a range of 2.2 to 3.5 times, and more preferably within a range of 2.2 to 3.0 times.

In the present invention, the term “dot enlargement rate” is calculated by the following expression.
dot enlargement rate=dot diameter (μm)/ink droplet diameter (μm)

The “dot diameter” refers to the diameter of a dot in a completely dried state when the dot is dropped on a recording medium. The completely dried state refers to a state in which the water content in the ink is reduced by 90% or more. For example, by using an infrared moisture meter IM-3SCV MODEL-2000 (manufactured by Matsuo Sangyo Co., Ltd), the amount of moisture can be measured. The dot diameters of 100 arbitrary dots in such a completely dried state are measured using a handy image analysis apparatus PIAS-II (manufactured by QEA), and the average value thereof is defined as the dot diameter in the present invention.

Furthermore, the term “ink droplet diameter” refers to a diameter obtained by converting the volume of one ink droplet into the volume of a sphere.

Examples of means for making the dot enlargement rate within the range of 2.2 to 3.5 times include the following means. Examples of the means include increasing the surface energy of the base material surface, suppressing the penetration into the base material, and reducing the surface tension of the liquid by applying a pre-coat liquid containing a resin before applying the ink. In a case where a pre-coat liquid is applied, it is preferable that the concentration of the resin in the pre-coat liquid be within a range of 0.1 to 5.0% by mass.

In addition, the minimum dot diameter of one liquid droplet of the inkjet ink which has landed on the recording medium is preferably 45 μm or less and more preferably in a range of 20 to 40 μm.

In the present invention, as described above, the “minimum dot diameter” refers to the minimum dot diameter among any dot diameters at 100 points in a completely dried state.

The minimum dot diameter of one droplet being 45 μm or less can be controlled by, for example, applying a pre-coat liquid, increasing the surface energy of the base material surface, suppressing penetration into the base material, or reducing the surface tension of the liquid, as described above.

The drying step is a step of drying the inkjet ink landed on the recording medium. In particular, the drying time until 80% by mass or more of the inkjet ink landed on the recording medium is evaporated is preferably set to 1 second or less.

In order to set the drying time to 1 second or less, as will be described later, in the inkjet recording apparatus, for example, a heat conduction type heating means such as a nichrome wire may be provided on the lower surface of the conveyance belt which conveys the recording medium. Further, by providing convection means for transferring heat by a fluid such as a gas or a liquid in the drying furnace, the amount of moisture can be reduced in a short time. Concretely, a heat conduction type heating means such as a nichrome wire is provided on the lower surface of the conveyance belt, and the surface temperature of the energized conveyance belt 221 is set within the range of 40-120° C. Furthermore, it is preferable that, in the drying furnace, the temperature of, for example, warm air to be blown onto the recording medium be within the range of 60-100° C.

### [Inkjet Ink]

The inkjet ink used in the recording method of the present invention will be described below.

The recording method of the present invention is an inkjet recording method using a water-based inkjet ink. The water-based inkjet ink is also referred to as “water-based ink” below.

The water-based ink according to the present invention contains at least water and a pigment, and the content of the pigment is 5% by mass or more with respect to the total amount of the ink.

### <Water>

The water that can be contained in the water-based ink according to the embodiment of the present invention is not particularly limited, and examples thereof include ion-exchanged water, distilled water, and pure water.

Further, the content of the water in the water-based ink is preferably 40% by mass or more and more preferably in a range of 50 to 60% by mass with respect to the total amount of the water-based ink.

### <Pigment>

The water-based ink according to the present invention contains a pigment, and the content of the pigment is 5% by mass or more with respect to the total amount of the ink. In a case where the content of the pigment is 5% by mass or greater, the liquid droplet amount can be reduced as compared with a case where the content of the pigment is small, and thus the amount of water applied onto the recording medium can also be reduced.

The content of the pigment is characteristically 5% by mass or more relative to the total amount of the water-based ink, more preferably in the range of 5 to 15% by mass and even more preferably in the range of 7 to by mass. As the content of the pigment increases, the amount of water applied to the recording medium can be reduced. On the other hand, when the content of the pigment is too large, it becomes difficult to form a desired dot diameter.

As the pigment, known pigments of the related art can be used without particular limitation, and for example, organic pigments such as an insoluble pigment and a lake pigment, and inorganic pigments such as titanium oxide can be preferably used.

The insoluble pigment is not particularly limited, but for example, azo, azomethine, methine, diphenylmethane, triphenylmethane, quinacridone, anthraquinone, perylene, indigo, quinophthalone, isoindolinone, isoindoline, azine, oxazine, thiazine, dioxazine, thiazole, phthalocyanine, diketopyrrolopyrrole and the like are preferable.

Examples of the organic pigment that can be preferably used include the following pigments.

Examples of the pigment for magenta or red include C. I. Pigment Red 2, C. I. Pigment Red 3, C. I. Pigment Red 5, C. I. Pigment Red 6, C. I. Pigment Red 7, C. I. Pigment Red 15, C. I. Pigment Red 16, C. I. Pigment Red 48:1, C. I. Pigment Red 53:1, C. I. Pigment Red 57:1, C. I. Pigment Red 122, C. I. Pigment Red 123, C. I. Pigment Red 139, C. I. Pigment Red 144, C. I. Pigment Red 149, C. I. Pigment Red 166, C. I. Pigment Red 177, C. I. Pigment Red 178, C. I. Pigment Red 202, C. I. Pigment Red 222, and C. I. Pigment Violet 19.

Examples of the pigment for orange or yellow include C. I. Pigment Orange 31, C. I. Pigment Orange 43, C. I. Pigment Yellow 12, C. I. Pigment Yellow 13, C. I. Pigment Yellow 14, C. I. Pigment Yellow 15, C. I. Pigment Yellow 15:3, C. I. Pigment Yellow 17, C. I. Pigment Yellow 74, C. I. Pigment Yellow 93, C. I. Pigment Yellow 128, C. I. Pigment Yellow 94, C. I. Pigment Yellow 138, and C. I. Pigment Yellow 155.

Examples of pigments for green or cyan include C. I. Pigment Blue 15, C. I. Pigment Blue 15:2, C. I. Pigment Blue 15:3, C. I. Pigment Blue 16, C. I. Pigment Blue 60, and C. I. Pigment Green 7.

Examples of pigments for black include C. I. Pigment Black 1, C. I. Pigment Black 6, and C. I. Pigment Black 7.

Titanium oxide has three crystal forms of an anatase type, a rutile type, and a brookite type, and generally used titanium oxide can be roughly classified into the anatase type and the rutile type. Although not particularly limited, a rutile type having a large refractive index and high concealability is preferable. Specific examples include the TR series from Fuji Titanium Industry Co., Ltd., the JR series from Tayca Corporation and Tipaque from Ishihara Sangyo Kaisha, Ltd.

The average particle diameter of the pigments in a dispersed state in the water-based ink is preferably 50 nm or more and less than 200 nm. Thus, the dispersion stability of the pigment can be improved, and the storage stability of the ink can be improved. The average particle diameter of the pigment can be determined by a commercially available particle diameter measuring instrument using a dynamic light scattering method, an electrophoresis method or the like.

The pigment can be used after being dispersed by a disperser together with a pigment-dispersing agent and other additives required according to various desired purposes. As the disperser, a conventionally known ball mill, sand mill, line mill, high-pressure homogenizer or the like can be used. In particular, it is preferable to disperse the pigment by a sand mill because the particle size distribution becomes sharp. In addition, the material of the beads used for the sand mill dispersion is not particularly limited, but is preferably zirconia or zircon from the viewpoint of preventing generation of bead fragments or contamination of ion components. The size of the beads is preferably within a range of 0.3 to 3 mm.

### <Pigment Dispersing Agent>

The water-based ink according to the present invention preferably also contains a pigment-dispersing agent for dispersing the pigment.

The pigment-dispersing agent is preferably a polymer dispersing agent having an anionic group, and those having a molecular weight within the range of 5000-200000 can be suitably used.

Examples of the polymer dispersing agent include a block copolymer having a structure derived from two or more monomers selected from styrene, styrene derivative, vinylnaphthalene derivative, acrylic acid, acrylic acid derivative, maleic acid, maleic acid derivative, itaconic acid, an itaconic acid derivative, fumaric acid, and fumaric acid derivative, a random copolymer, salts thereof, polyoxyalkylene, and polyoxyalkylene alkyl ether.

The polymer dispersing agent preferably has an acryloyl group and is preferably added after being neutralized with a neutralizing base. The neutralizing base is preferably an organic base such as ammonia, monoethanolamine, diethanolamine, triethanolamine, or morpholine.

In a case where the pigment is titanium oxide, the titanium oxide is preferably dispersed with a polymer dispersing agent having an acryloyl group.

The content of the pigment-dispersing agent in the water-based ink is preferably in the range of 1.5 to 3% by mass with respect to the total amount of the water-based ink. In addition, the content of the pigment-dispersing agent in the water-based ink is preferably in a range of 10 to 100% by mass and more preferably in a range of 10 to 50% by mass with respect to the content of the pigment.

The pigment in the water-based ink is particularly preferably in the form of a so-called capsule pigment coated with a polymer dispersing agent. As a method for coating the pigment with the polymer dispersing agent, various known methods can be used. Preferred examples of the methods include a phase inversion emulsification method, an acid precipitation method, or a method in which a pigment is dispersed with a polymerizable surfactant, a monomer is supplied thereto, and coating is performed while polymerization is performed. In a particularly preferred method, the water-insoluble resin is dissolved in an organic solvent such as methyl ethyl ketone, and the acidic groups in the resin are partially or completely neutralized with a base. Thereafter, a pigment and ion-exchanged water are added and dispersed, the organic solvent is removed, and water is added as necessary for preparation.

### <Organic Solvent>

The water-based ink according to the present invention preferably contains an organic solvent.

The organic solvent that the water-based ink may contain is preferably a water-soluble organic solvent. Examples of the water-soluble organic solvents include polyhydric alcohols, monohydric alcohols, amines, amides, glycol ethers, and 1,2-alkanediols having 4 or more carbon atoms. Among these, from the viewpoint of affinity with water, it is preferable to have two or more hydroxy groups in one molecule, and it is more preferable to have three or more hydroxy groups in one molecule. Having two or more hydroxy groups in one molecule refers to a polyhydric alcohol.

Examples of the polyhydric alcohols include ethylene glycol, diethylene glycol, triethylene glycol, tetraethylene glycol, polyethylene glycol having 5 or more ethylene oxide groups, propylene glycol, dipropylene glycol, tripropylene glycol, polypropylene glycol having 4 or more propylene oxide groups, butylene glycol, hexanediol, pentanediol, glycerin, hexanetriol, thiodiglycol and the like.

Examples of the monohydric alcohols include methanol, ethanol, 1-propanol, 2-propanol, 1-butanol, 2-butanol, 2-methyl-1-propanol, t-butanol, 3-methoxy-1-butanol, 3-methoxy-3-methylbutanol, 1-octanol, 2-octanol, n-nonyl alcohol, tridecyl alcohol, n-undecyl alcohol, stearyl alcohol, oleyl alcohol, benzyl alcohol and the like.

Examples of the amines include ethanolamine, diethanolamine, triethanolamine, N-methyldiethanolamine, N-ethyldiethanolamine, morpholine, N-ethylmorpholine, ethylenediamine, diethylene diamine, triethylenetetramine, tetraethylenepentamine, polyethyleneimine, pentamethyldiethylenetriamine, tetramethylpropylenediamine and the like.

Examples of the amides include formamide, N,N-dimethylformamide, N,N-dimethylacetamide and the like.

Examples of the glycol ethers include ethylene glycol monoethyl ether; ethylene glycol monobutyl ether; diethylene glycol monoethyl ether; diethylene glycol monobutyl ether; triethylene glycol monobutyl ether; propylene glycol monopropyl ether; dipropylene glycol monomethyl ether and tripropylene glycol monomethyl ether.

Examples of the 1,2-alkanediols having 4 or more carbon atoms include 1,2-butanediol, 1,2-pentanediol, 1,2-hexanediol, and 1,2-heptanediol.

The content of the organic solvent in the water-based ink is preferably in the range of 0.1 to 25% by mass and more preferably in the range of 5 to 20% by mass with respect to the total amount of the water-based ink.

The organic solvent may be used alone with only one type or in combination of two or more kinds thereof.

### <Surfactant>

The water-based ink according to the present invention may contain a surfactant. As the surfactant which can be contained in the water-based ink, any one of an anionic surfactant, a cationic surfactant, a nonionic surfactant and an amphoteric surfactant may be used.

The content of the surfactant in the water-based ink is preferably within a range of 0.1 to 1% by mass

with respect to the total amount of the water-based ink. Only one type of surfactant may be used alone, or two or more types may be used in combination.

### <Other Components>

The water-based ink according to the present invention may appropriately contain other components such as resin fine particles, a crosslinking agent, an antifungal agent, and a bactericidal agent, within a range that does not impair the effects of the present invention.

The water-based ink of the present invention may contain various known additives such as ultraviolet absorbers described in Japanese Unexamined Patent Publication No. S57-74193, S57-87988 and S62-261476, anti-fading agents described in Japanese Unexamined Patent Publication No. S57-74192, S57-87989, S60-72785, S61-146591, H1-95091 and H3-13376, fluorescent whitening agents described in Japanese Unexamined Patent Publication No. S59-42993, S59-52689, S62-280069, 61-242871, and H4-219266, defoaming agents, lubricants such as diethylene glycol, preservatives, thickeners, and antistatic agents.

### <Physical Properties of Water-Based Ink>

The viscosity of the water-based ink at 25° C. is preferably within the range of 0.5-60 cP from the viewpoint of inkjet ejecting properties.

### <Recording Medium>

The recording medium that can be used in the present invention is not particularly limited and may be any of a high water-absorptive recording medium, a low water-absorptive recording medium, and a non-water-absorptive recording medium.

Examples of the high water-absorptive recording medium include high-quality sheet and plain sheet.

Examples of the low water-absorptive recording medium include coated sheet, matte coated sheet, and art sheet.

Examples of the non-water-absorptive recording medium include recording media having a surface made of plastic, metal, glass, leather, or the like.

Furthermore, examples of the form of the recording medium in the present invention include a flat sheet or roll sheet that has been cut to a certain size, but a flat sheet is preferable from the viewpoint of preventing deformation such as the recording medium becoming wavy.

### [Pre-Coat Liquid]

In the recording method of the present invention, a pre-coat liquid is preferably applied onto the recording medium in advance before the water-based ink is applied.

When an image is recorded on a recording medium by an inkjet method, the pre-coat liquid can have a function of accelerating the image formation of the ink, controlling the dot enlargement rate in the above-described range, or improving the image quality.

The step of applying the pre-coat liquid (the pre-coat liquid application process) may be performed continuously with the same system as that for the step of applying the water-based ink onto the recording medium. Alternatively, the pre-coat liquid application step is not an essential step in the inkjet recording method of the present invention, and for example, may be performed in a system different from that for the application of the water-based ink onto the recording medium.

The pre-coat liquid applying step can be performed by, for example, a roll coating method, an inkjet method, a bar coater method, or a spray method.

The pre-coating liquid used in the present invention preferably contains water as a solvent.

### <Water and Other Additives>

The water contained in the pre-coat liquid according to the present invention is not particularly limited, and may be ion-exchanged water, distilled water, or pure water.

The pre-coat liquid according to the present invention may contain an organic solvent in addition to water as a solvent. The solvent can be removed during the drying of the pre-coat liquid in the subsequent stage.

Other components such as a surfactant, a cross-linking agent, an antifungal agent, and a bactericidal agent can be appropriately blended in the pre-coat liquid as long as the effects of the present invention are not impaired.

Furthermore, the pre-coat liquid according to the present invention can also contain various known additives, for example, ultraviolet absorbers described in Japanese Unexamined Patent Publication No. S57-74193, S57-87988 and S62-261476, anti-fading agents described in Japanese Unexamined Patent Publication No. S57-74192, S57-87989, S60-72785, S61-146591, H1-95091, H3-13376 and the like, various anionic, cationic or nonionic surfactants, fluorescent whitening agents described in Japanese Unexamined Patent Publication No. S59-42993, S59-52689, S62-280069, S61-242871, H4-219266 and the like, antifoaming agents, lubricants such as diethylene glycol, preservatives, thickeners, antistatic agents and the like.

The pre-coat layer is preferably formed by directly applying the pre-coat liquid as a coating liquid onto a recording medium, followed by drying. Here, it is preferable that the additive preferably used in the pre-coat liquid is sufficiently dissolved before using the pre-coat liquid as the coating liquid.

### [Inkjet Recording System]

The inkjet recording system of the present invention is a recording system that performs recording by ejecting droplets of an inkjet ink onto recording media while conveying the recording media, wherein the conveyance speed of the recording media is 500 mm/s or more, the inkjet ink contains at least water and pigments, content of the pigments is 5% by mass or more with respect to the total amount of the inkjet ink, and the volume of one droplet of the inkjet ink is 3 pL or less.

In particular, the inkjet recording system of the present invention performs recording on a recording medium by an inkjet method using the inkjet recording apparatus described below so that the conveyance speed of the recording medium is 500 mm/s or more and the volume of one droplet of the inkjet ink is 3 pL or less. As described above, the water-based ink having a pigment content of 5% by mass or more is used as the inkjet ink.

### [Inkjet Recording Apparatus]

Next, an inkjet recording apparatus used in the inkjet recording method of the present invention will be described.

In the following description, for convenience, a printing width direction which is an arrangement direction of the nozzles 111 of the inkjet head 100 is referred to as a right-left direction. Further, a direction in which the recording medium is conveyed below the nozzles 111 is referred to as a front-back direction, and a direction orthogonal to the right-left direction and the front-back direction is referred to as an up-down direction. An arrow in a channel in the drawings indicates a direction in which ink flows.

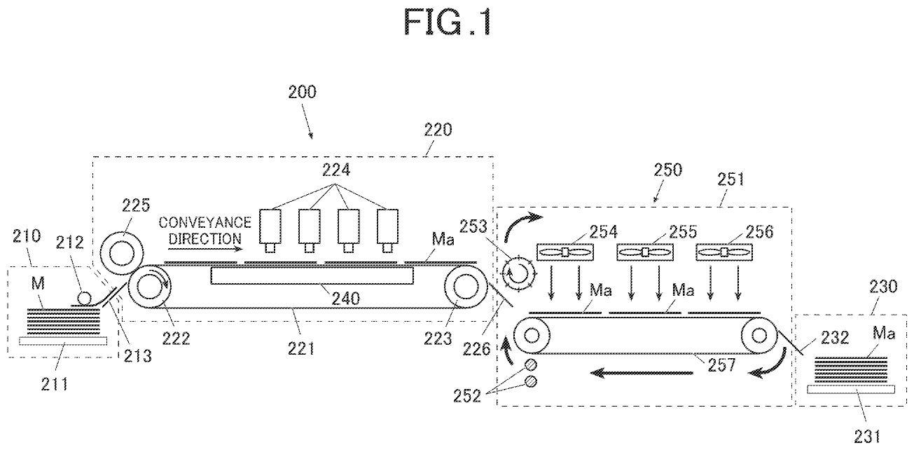

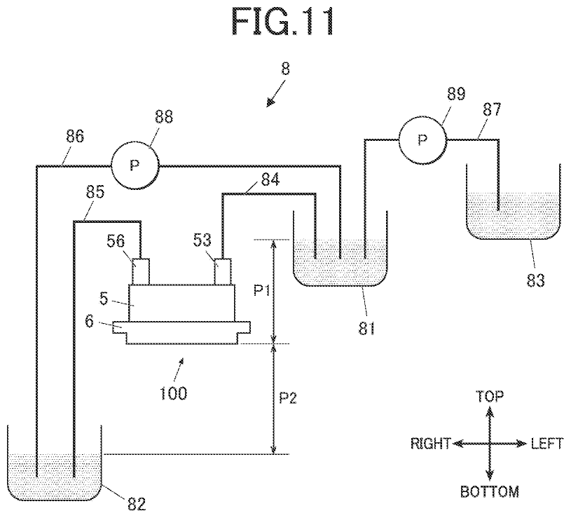

As illustrated in FIG. 1, the inkjet recording apparatus 200 includes a sheet feed section 210, an image recording section 220, a first dryer 240, a second dryer 250, a sheet ejection section 230, and an ink circulation system 8 (see FIG. 11). The ink circulation system 8 is a unit (ink circulation unit) that ejects liquid droplets while circulating ink. The inkjet recording apparatus 200 conveys the recording medium M stored in the sheet feed section 210 to the image recording section 220, and forms an image on the recording medium M in the image recording section 220. Next, after being dried in the first dryer 240 and the second dryer 250, the recording medium Ma on which an image has been formed is conveyed to the sheet ejection section 230.

The sheet feed section 210 includes a sheet feed tray 211 that stores the recording medium M, a recording medium feed roller 212 that conveys and supplies the recording medium M from the sheet feed tray 211 to the image recording section 220, a recording medium guide 213, and the like.

The image recording section 220 includes a conveyance belt 221, driving rollers 222 and 223 that drive the conveyance belt 221, a conveyance mechanism such as a press roller 225, and a head unit 224.

The recording medium M is stored in a sheet feed tray 211 in a stacked state, and is pulled out from the sheet feed tray 211 by a recording medium feed roller 212 and a recording medium guide 213. Thereafter, the recording medium M passes between a driving roller 222 and a press roller 225, is placed on a conveyance belt 221, and is conveyed to a head unit 224.

Here, examples of the form of the recording medium M include the roll sheet, flat sheet, and the like, but the flat sheet is preferable, and it is preferable that the recording medium M is conveyed in a flat sheet-fed manner from the viewpoint of preventing sheet deformation.

The conveyance belt 221 is driven in a conveyance direction by the driving roller 222 and the driving roller 223, and an upper surface of the conveyance belt 221 is a conveyance surface on which the recording medium M is placed.

The conveyance belt 221 conveys the recording medium M along the conveyance surface by moving in the direction of the arrow in FIG. 1 in a state of holding the recording medium M on the conveyance surface. The conveyance belt 221 includes a claw portion and an intake portion (not illustrated). The conveyance belt 221 holds the recording medium M on the conveyance surface by holding an end portion of the recording medium M by the claw portion and pulling the recording medium M to the conveyance surface by the intake portion.

Here, the conveyance belt 221 is controlled by a control device (not shown) such that the conveyance speed of the recording media M is equal to or greater than 500 mm/s. The conveyance speed is preferably 1000 mm/s or more, and preferably within a range of 1000-2000 mm/s.

Although the conveyance belt 221 and the driving rollers 222 and 223 have been described as a conveyance mechanism for the recording medium M, the present invention is not limited thereto. The conveyance mechanism may have a configuration in which the conveyance belt is a drum-type conveyance drum (not shown), and the recording medium placed on the upper surface of the conveyance drum is conveyed while rotating the conveyance drum.

The first dryer 240 is installed on the lower surface of the conveyance belt 221. Specifically, the first dryer 240 is a heat conduction-type heating means and includes a nichrome wire. The nichrome wire is provided inside the entire region of the conveyance belt 221 so as to be at a constant distance from the upper surface of the conveyance belt 221. Next, when the nichrome wire is energized, the nichrome wire itself generates heat, and the heat can be transmitted through the conveyance belt 221 to the back surface of the recording medium M on the conveyance belt 221 with which it is in contact.

Here, since the nichrome wire is provided in the entire region of the conveyance belt 221, it is possible to generate heat in the entire region of the conveyance belt 221. Since the conveyance belt 221 has a smooth surface without irregularities, the upper surface of the conveyance belt 221 can uniformly come into contact with the recording medium M. Since the distance from the nichrome wire to the upper surface of the conveyance belt 221 is constant, heat can be uniformly transferred to the recording medium M on the conveyance belt 221, and the recording medium M can be uniformly heated and dried.

Note that the surface temperature of the conveyance belt 221 energized by the first dryer 240 is preferably within a range of 40-120° C.

The head unit 224 forms an image by ejecting ink onto the recording medium M at an appropriate timing according to the movement of the conveyance belt 221 on which the recording medium M is held, based on image data. The head unit 224 is arranged so that an ink ejection surface faces the conveyance belt 221 with a predetermined distance therebetween. In the inkjet recording apparatus 200 of the present embodiment, for example, four head units 224 respectively corresponding to four colors of ink of yellow (Y), magenta (M), cyan (C), and black (K) are arranged. The four units 224 are arranged at predetermined intervals in the order of the colors Y, M, C, and K from the upstream side in the conveyance direction of the recording medium M.

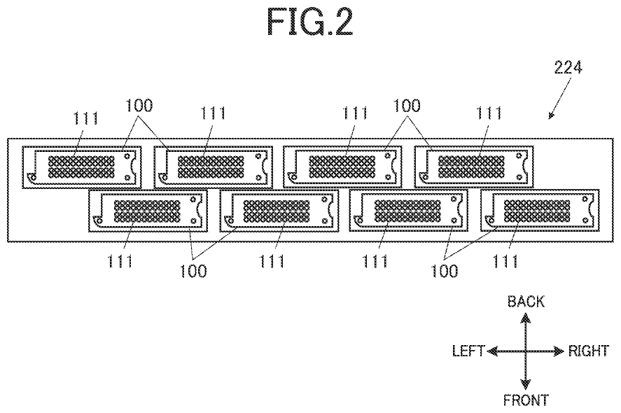

In the head unit 224, for example, as shown in FIG. 2, a pair of inkjet heads 100 adjacent to each other in the front-back direction are arranged in a staggered manner at different positions in the front-back direction. The inkjet recording apparatus 200 is an inkjet recording apparatus 200 that performs image recording of a one pass drawing system using a line head.

Different from the first dryer 240, the second dryer 250 is a convection type heating means. The second dryer 250 includes a drying furnace 251, a second nichrome wire 252 provided inside the drying furnace 251, a cross flow fan 253, a first axial flow fan 254, a second axial flow fan 255, a third axial flow fan 256, a conveyance belt 257, and the like.

The second nichrome wire 252 is disposed so that the second nichrome wire 252 itself generates heat by being energized, and can heat the air in the drying furnace 251.

The cross flow fan 253 generates a flow for sending out the air heated by the second nichrome wire 252 in a direction of an arrow in FIG. 1 (clockwise in FIG. 1).

Here, the cross-flow fan 253 is a fan having a relatively small diameter and being long in a lateral direction, and refers to a fan that draws in air from one radial direction of an impeller and blows out air from an opposite radial direction. The cross flow fan 253 is also referred to as a lateral flow fan.

In addition, the first to third axial flow fans 254 to 256 are provided on the upper side in the drying furnace 251, that is, on the upper side of the conveyance belt 257, and are provided so as to apply warm air substantially perpendicularly to the surface of the recording medium Ma on the conveyance belt 257.

The conveyance belt 257 receives the recording medium Ma recorded by the image recording section 22 and dried by the first dryer 240 from the recording medium guide 226, and conveys the recording medium Ma in the conveyance direction.

The temperature of the warm air blown by the first axial flow fan to the third axial flow fan 254 to 256 is preferably higher than that of the first dryer 240, and is preferably within a range of 60-100° C. As a result, the ink can be dried by evaporating the organic solvent, which is less likely to evaporate than water, at once with a relatively strong wind force at a high temperature.

Here, the viscosity of the ink on the surface of the recording medium Ma has already been increased by the drying by the first dryer 240. Therefore, even if a strong wind is blown at once by the second dryer 250, the ink does not move on the surface of the recording medium Ma, and the organic solvent that is hard to evaporate can be efficiently evaporated in a short time.

In the present invention, in particular, setting the drying time by the first dryer 240 and the second dryer 250 to 1 second or less is preferable from the viewpoint of sheet deformation. That is, it is preferable that the time for which the recording medium passes through the first dryer 240 and the second dryer 250 is 1 second or less.

The sheet ejection section 230 includes a plate-shaped sheet ejection tray 231 on which the recording medium Ma sent from the second dryer 250 is placed, and a recording medium guide 232 that conveys the recording medium Ma to the sheet ejection tray 231.

The recording medium Ma sent out from the image recording section 220 is stored in the sheet ejection tray 231 via the recording medium guide 232.

Note that the first dryer which is a heat conduction type heating means and the second dryer which is a convection type heating means are used as the drying means, but either one of the drying means may be used.

### [Inkjet Head]

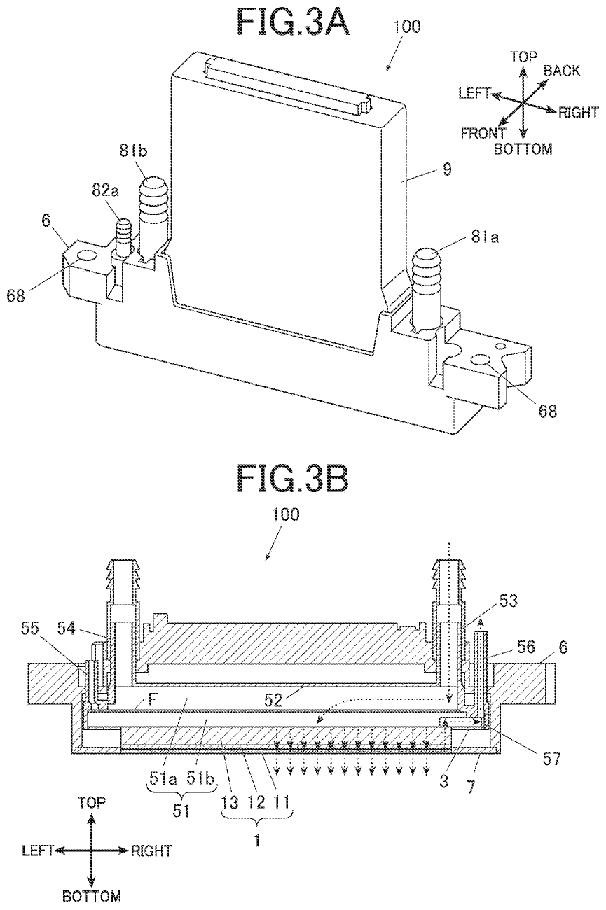

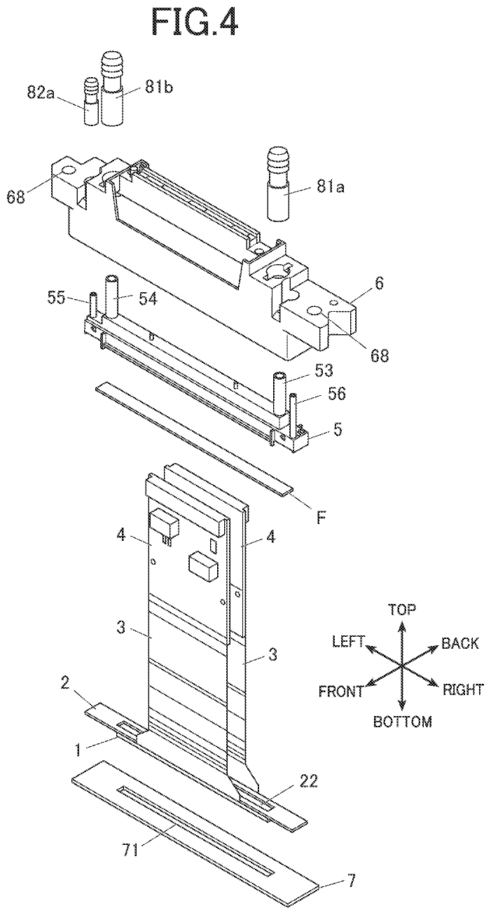

As illustrated in FIGS. 3A, 3B and 4, the inkjet head 100 includes a head chip 1, a wiring board 2, a drive circuit board 4, a manifold 5, a housing 6, a cap receiving plate 7, and a cover member 9.

The head chip 1 is disposed on the wiring board 2.

The drive circuit board 4 is connected to the wiring board 2 via the flexible board 3.

The manifold 5 stores ink to be supplied to the pressure chambers 131 in the head chip 1.

The manifold 5 is stored inside the housing 6.

The cap receiving plate 7 is attached so as to close the bottom surface opening of the housing 6.

The cover member 9 is attached to the housing 6.

Note that the illustration of the manifold 5 is omitted in FIG. 3A, and the illustration of the cover member 9 is omitted in FIGS. 3B and 4.

In the present embodiment, an example in which the number of rows of the nozzles 111 of the head chip 1 is four will be described. However, the number of rows and the arrangement of the nozzles 111 are changeable as appropriate, and for example, may be any one of one to three rows, and may be five or more rows.

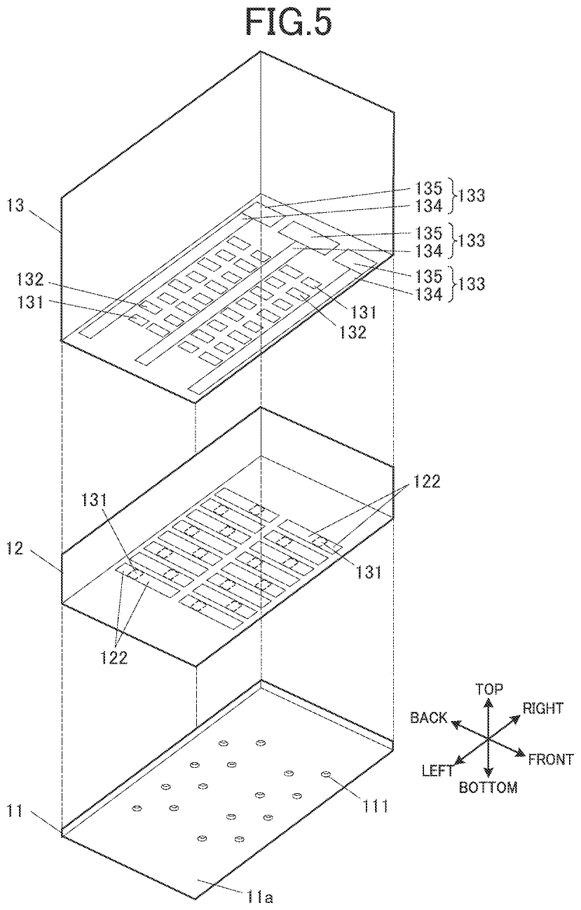

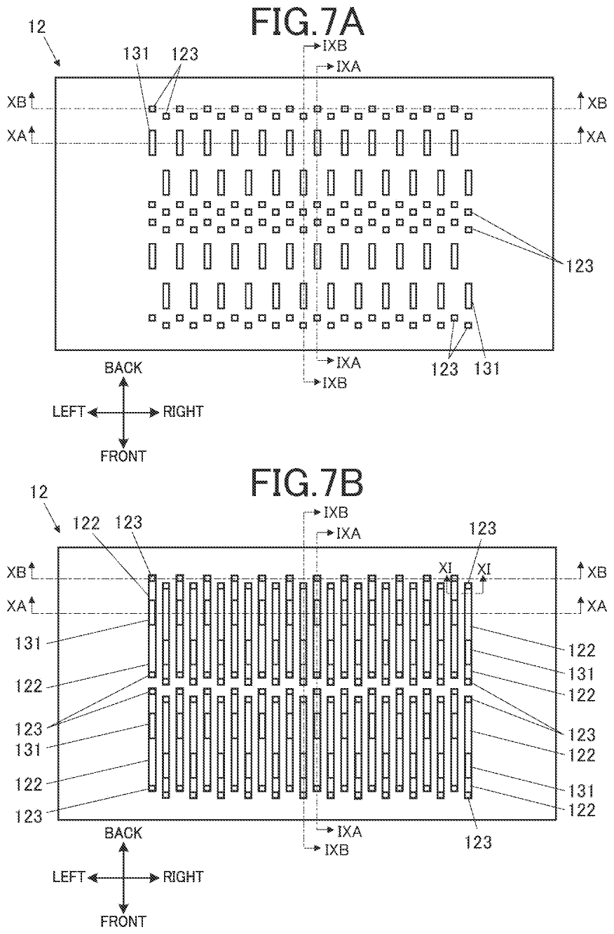

The head chip 1 is a member having a substantially quadrangular prism shape elongated in the right-left direction, and is configured by stacking a pressure chamber board 13, a channel board 12, and a nozzle board 11 in this order (refer to FIGS. 5 to 14).

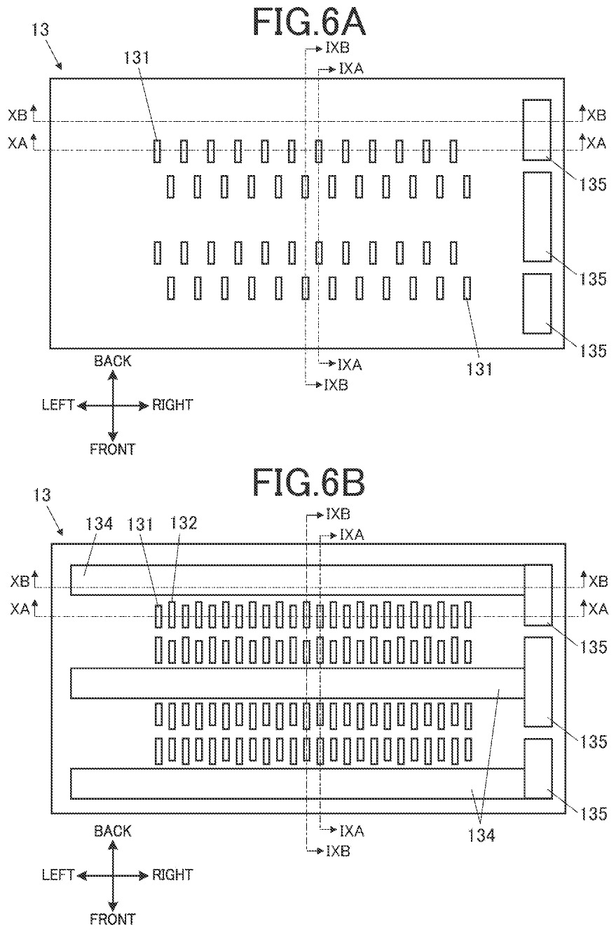

The pressure chambers 131, air chambers 132, common ink discharge paths 133, and the like are provided in the pressure chamber board 13 (refer to FIGS. 5, 6A and 6B).

The pressure chambers 131 and the air chambers 132 are provided in large numbers so as to be alternately arranged in the right-left direction, and are provided in four rows in the front-back direction.

The pressure chamber 131 has a substantially rectangular shaped cross section, is formed along the up-down direction, has an inlet on the upper surface of the pressure chamber board 13, and has an outlet on the lower surface. In addition, the pressure chamber 131 communicates with the ink storage 51 at an end portion in the upper direction. The pressure chamber 131 is supplied with ink from the ink storage 51, and the pressure chamber 131 stores inside the ink to be ejected from the nozzle 111.

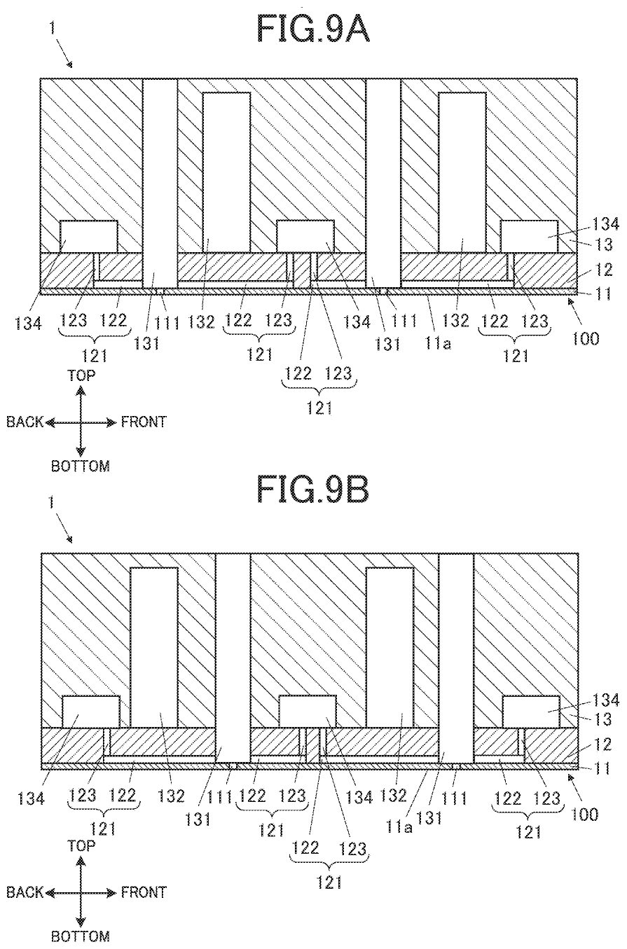

In addition, the pressure chamber 131 is formed along the up-down direction across the pressure chamber board 13 and the channel board 12 so as to have a substantially rectangular shaped cross section having the same area, and communicates with the nozzle 111 at an end portion in the lower direction. See FIG. 9A, FIG. 9B, and the like.

The air chamber 132 has a substantially rectangular shaped cross section slightly larger than that of the pressure chamber 131, and is formed parallel to the pressure chamber 131 along the up-down direction. In addition, unlike the pressure chamber 131, the air chamber 132 does not communicate with the ink storage 51, and ink does not flow into the air chamber 132. Further, the air chamber 132 does not communicate with the nozzle 111 (refer to FIG. 9A, FIG. 9B, and the like).

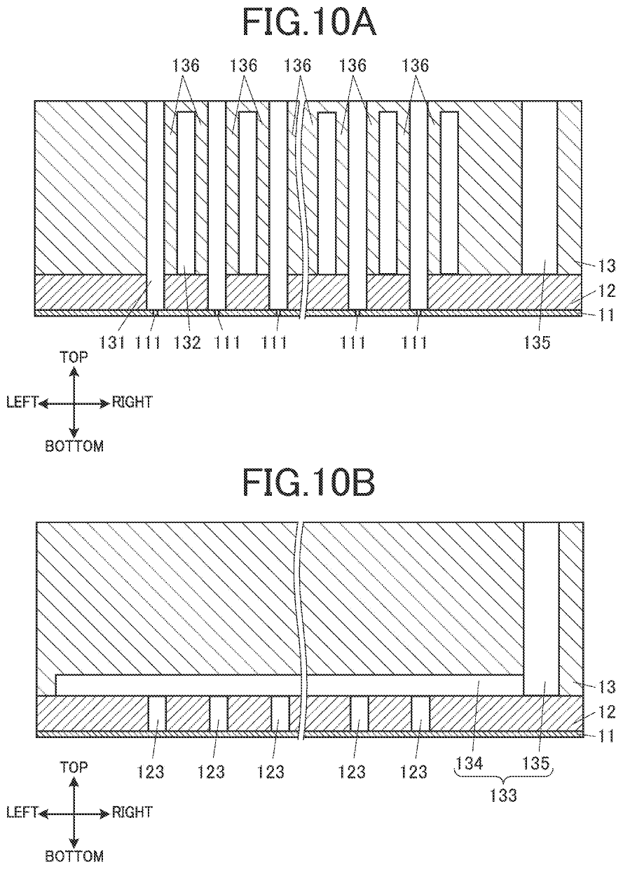

The pressure chamber 131 and the air chamber 132 are formed separated from each other by a partition wall 136 serving as a pressure-generating unit formed of a piezoelectric material (see FIG. 10A). The partition wall 136 is provided with a drive electrode (not shown). When a voltage is applied to the drive electrode, a portion of the partition wall 136 between adjacent ones of the pressure chambers 131 repeatedly undergoes shear-mode displacement, and thus a pressure is applied to the ink in each of the pressure chambers 131. Among the pressure chambers 131 shown in FIGS. 5 to 10B and the like, the pressure chambers 131 located at the end portion in the right-left direction, which have the partition wall 136 only on one side, is not used, and the other pressure chambers 131 having the partition walls 136 on both sides are used.

The air chamber 132 may not be provided and only the pressure chamber 131 may be formed, but as described above, it is preferable that the pressure chamber 131 and the air chamber 132 are alternately provided. Accordingly, since the pressure chambers 131 can be prevented from being adjacent to each other, when the partition wall 136 adjacent to one pressure chamber 131 is deformed, the other pressure chambers 131 can be prevented from being affected.

The common ink discharge path 133 is formed by connection of a first common ink discharge path 134 and a second common ink discharge path 135 (see FIGS. 5, 6B, and the like).

The first common ink discharge paths 134 are provided on the lower surface side of the pressure chamber board 13 along the right-left direction in three rows on the front side, the rear side, and the central portion of the head chip 1 so as to avoid the portions where the pressure chambers 131 and the air chambers 132 are provided. In addition, a plurality of individual ink discharge paths 121 provided in the channel board 12 are connected to the lower surface side of the first common ink discharge path 134. Then, the ink flowing from those individual ink discharge paths 121 (the second individual ink discharge paths 123 ) can join together in the first common ink discharge path 134 (see FIGS. 6B, 7A, and 9A). In addition, the first common ink discharge path 134 is connected to a second common ink discharge path 135 capable of discharging ink to the outside of the head chip 1 in the vicinity of the right end portion. Therefore, the first common ink discharge path 134 is a channel through which the ink flowing from the individual ink discharge path 121 (second individual ink discharge path 123) flows toward the second common ink discharge path 135.

The second common ink discharge path 135 is formed along the up-down direction similarly to the pressure chambers 131. In addition, the second common ink discharge path 135 communicates with the first common ink discharge path 134 on the lower surface side of the pressure chamber board 13 and communicates with the discharge liquid chamber 57 on the upper surface side. Then, the second common ink discharge path 135 is a channel for discharging the ink flowing from the first common ink discharge path 134 to the outside of the head chip 1 toward the upper side (the side opposite to the nozzle board 11 side). The second common ink discharge path 135 is provided in the vicinity of a right end portion of the head chip 1 and communicates with the first common ink discharge path 134. In addition, by providing the second common ink discharge path 135 so as to have a larger volume than the individual pressure chambers 131, it is possible to increase the discharge efficiency of ink.

In the channel board 12, a pressure chamber 131 and an individual ink discharge path 121 provided so as to branch from the pressure chamber 131 are formed (see FIGS. 9A and 9B, and the like).

The pressure chamber 131 is formed along the up-down direction across the channel board 12 and the pressure chamber board 13 so as to have a substantially rectangular shaped cross section having the same area.

The individual ink discharge path 121 has one end portion connected to the pressure chamber 131 and the other end portion connected to the first common ink discharge path 134, and serves as a channel for discharging the ink in the pressure chamber 131 to the first common ink discharge path 134.

It is preferable that at least two individual ink discharge paths 121 are provided in each of the pressure chambers 131 from the viewpoint of making it easy to discharge air bubbles, foreign substance, and the like together with ink. Further, it is preferable to provide one individual ink discharge path 121 each in the front direction and the rear direction of the pressure chamber 131, that is, two in total, because it is possible to obtain the effect of making it easier to eject air bubbles, foreign substance, and the like together with ink and also because of high manufacturing efficiency. See FIGS. 9A and 9B.

The channel board 12 is preferably a board formed of silicon, stainless steel (SUS), nickel, or 42 alloy described above. By using such a board, it is easy to process the individual ink discharge path 121 (high accuracy), and it is possible to easily keep the ink temperature uniform due to high thermal conductivity.

In addition, among these, it is preferable to use a board of a material having a thermal expansion coefficient close to that of the material forming the pressure chamber board 13.

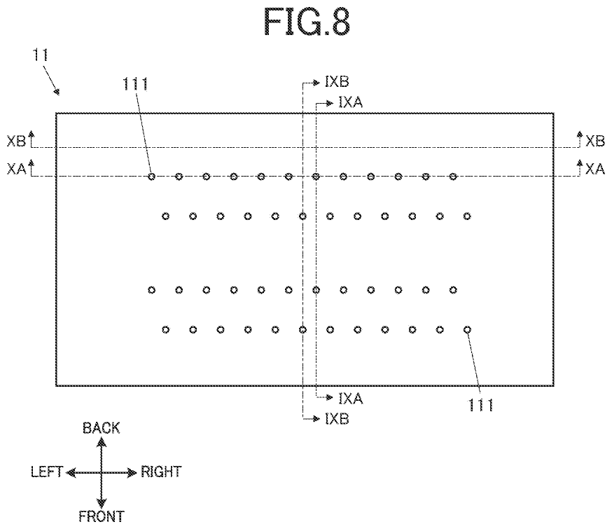

The nozzle board 11 is provided with a nozzle 111 which is a hole penetrating in a thickness direction (up-down direction) (refer to FIG. 8). The nozzle 111 communicates with the pressure chamber 131 and serves as an ejection port for ejecting the ink stored in the pressure chamber 131 when pressure is applied to the ink in the pressure chamber 131. Further, the nozzles 111 in the present embodiment are arranged in the right-left direction, and form four rows in the front-back direction.

The shape of the nozzle 111 may be a circular hole or a polygonal hole.

In addition, it is preferable that the nozzle board 11 constitute one of the channel walls of the first individual ink discharge path 122 as shown in FIGS. 9A and 9B. In addition, since the nozzle board 11 is thin, the nozzle board 11 can function as a damper that can be slightly elastically deformed by pressure to change the volume of the channel.

As described above, the nozzle board 11 is manufactured by performing etching processing on the silicon substrate.

As illustrated in FIG. 4, on the upper surface of the head chip 1 a wiring board 2 is arranged, and at both edge parts of the wiring board 2 along the front-back direction, two flexible boards 3 connected to the drive circuit board 4 are arranged.

The wiring board 2 is formed in a substantially rectangular plate shape that is long in the right-left direction, and has an opening 22 at a substantially central portion thereof. Each width of the wiring board 2 in the right-left direction and the front-back direction is formed to be larger than the head chip 1.

The opening 22 is formed into a substantially rectangular shape elongated in a right-left direction. In a state where the head chip 1 is attached to the wiring board 2 the inlet of each pressure chamber 131 and the outlet of the second common ink discharge path 135 in the head chip 1 are exposed to the upper side.

The flexible board 3 electrically connects the drive circuit board 4 and the electrode portion of the wiring board 2. Then, a signal from the drive circuit board 4 can be applied to the drive electrode provided on the partition wall 136 in the head chip 1 via the flexible board 3.

In addition, a lower end portion of a manifold 5 is attached and fixed to an outer edge portion of the wiring board 2 by adhesion. That is, the manifold 5 is arranged on the inlet side (upper side) of the pressure chambers 131 of the head chip 1 and is connected to the head chip 1 via the wiring board 2.

The manifold 5 is a member formed of resin, is provided on top of the pressure chambers 131 of the head chip 1 and stores ink to be introduced into the pressure chambers 131. Specifically, as illustrated in FIG. 3B and others, the manifold 5 is formed elongated in the right-left direction. The manifold 5 includes a hollow main body portion 52 constituting an ink storage 51, and first to fourth ink ports 53 to 56 constituting ink channels. Furthermore, the ink storage 51 is divided into two, a first liquid chamber 51a on the upper side and a second liquid chamber 51b on the lower side, by a filter F for removing dust in the ink.

The first ink port 53 communicates with a right upper end portion of the first liquid chamber 51a and is used to introduce the ink into the ink storage 51. Further, a first joint 81a is externally inserted into a tip end portion of the first ink port 53.

The second ink port 54 communicates with a left upper end portion of the first liquid chamber 51a, and is used to remove air bubbles in the first liquid chamber 51a. A second joint 81b is externally inserted into a tip end portion of the second ink port 54.

The third ink port 55 communicates with a left upper end portion of the second liquid chamber 51b and is used to remove air bubbles in the second liquid chamber 51b. Furthermore, a third joint 82a is externally inserted into a tip end portion of the third ink port 55.

The fourth ink port 56 communicates with a discharge liquid chamber 57 that communicates with the second common ink discharge path 135 of the head chip 1. The ink discharged from the head chip 1 is discharged to the outside of the inkjet head 100 through the fourth ink port 56.

The housing 6 is, for example, a member formed by die-casting using aluminum as a material, and is formed to be long in the right-left direction. In addition, the housing 6 is formed so as to be able to accommodate the manifold 5 to which the head chip 1, the wiring board 2, and the flexible board 3 are attached, and the bottom surface of the housing 6 is opened. Mounting holes 68 for mounting the housing 6 to the printer body are formed at both end portions of the housing 6 in the right-left direction.

The cap receiving plate 7 has a nozzle opening 71 which is formed elongated in the right-left direction and formed in a substantially central portion thereof. The cap receiving plate 7 is attached so as to close the bottom surface opening of the housing 6 such that the nozzle board 11 is exposed through the nozzle opening 71.

### [Ink Circulation System]

The ink circulation system (ink circulation unit) 8 is an ink supplier for generating a circulation flow of ink from the pressure chamber 131 in the inkjet head 100 to the individual ink discharge path 121. The ink circulation system 8 is composed of a supply sub-tank 81, a circulation sub-tank 82, a main tank 83, ink channels 84, 85, 86, and 87, liquid feed pumps 88 and 89, and the like (see FIG. 11).

By circulating the ink by the ink circulation system 8, the ejection stability of the ink is improved.

The supply sub-tank 81 is filled with ink to be supplied to the ink storage 51 of the manifold 5, and is connected to the first ink port 53 by an ink channel 84.

The circulation sub-tank 82 is filled with the ink discharged from the discharge liquid chamber 57 of the manifold 5, and is connected to the fourth ink port 56 by the ink channel 85.

In addition, the supply sub-tank 81 and the circulation sub-tank 82 are provided at different positions in the up-down direction (gravity direction) with respect to the nozzle surface (hereinafter, also referred to as a “position reference surface”) of the head chip 1. As a result, a pressure P1 due to the head difference between the position reference surface and the supply sub-tank 81 and a pressure P2 due to the head difference between the position reference surface and the circulation sub-tank 82 are generated.

In addition, the supply sub-tank 81 and the circulation sub-tank 82 are connected to each other by the ink channel 86. Then, the ink can be returned from the circulation sub-tank 82 to the supply sub-tank 81 by the pressure applied by the pump 88.

The main tank 83 is filled with ink to be supplied to the supply sub tank 81, and is connected to the supply sub-tank 81 by an ink channel 87. Then, the ink can be supplied from the main tank 83 to the supply sub-tank 81 by the pressure applied by the pump 89.

In addition, it is possible to adjust the pressure P1 and the pressure P2 by appropriately changing the ink filling amount in each sub-tank and the position of each sub-tank in the up-down direction (gravity direction). The ink in the inkjet head 100 can be circulated at an appropriate circulating flow rate by the difference between the pressure P1 and the pressure P2. Thus, air bubbles, foreign substances, and the like generated in the head chip 1 are removed, clogging of the nozzle 111, an ejection failure, and the like are suppressed, and the ejection stability of the ink becomes favorable.

In addition, as an example of the ink circulation system 8, a method of controlling the circulation of the ink by the head difference has been described, but as a matter of course, the method can be appropriately changed as long as the configuration can generate the circulation flow of the ink.

In addition, in the above description, the share mode type inkjet head is used, but for example, a bend mode type inkjet head may be used.

### Examples

Hereinafter, the present invention will be specifically described with reference to Examples, but the present invention is not limited thereto. Note that in the following examples, operations were performed at room temperature (25° C.) unless otherwise specified. Further, unless otherwise specified, “%” and “parts” mean “% by mass” and “parts by mass”, respectively.

### <Preparation of Cyan Pigment Dispersion Liquid>

### (Pigment)

Cyan pigment (pigment blue 15:3, available from Tokyo Chemical Industry Co., Ltd.)

### (Pigment-Dispersing Agent)

DISPER BYK190 (manufactured by BYK Japan KK, solid contents: 40% by mass)

18.0 parts by mass of a cyan pigment, 9 parts by mass of a pigment-dispersing agent (DISPER BYK190), and 73 parts by mass of ion-exchanged water were added and mixed.

Thereafter, the mixture was dispersed using a sand grinder filled with zirconia beads having an average particle diameter of 0. 5 mm at a volume fraction of 50% to prepare a cyan pigment dispersion liquid having a content of the cyan pigments of 18% by mass.

### <Preparation of Magenta Pigment Dispersion Liquid>

### (Pigment)

Magenta pigment (pigment red 122, FASTOGEN SUPER MAGENTA RG, manufactured by DIC Corporation (“FASTOGEN” is a registered trademark of the company))

A magenta pigment dispersion liquid having a magenta pigment content of 18% by mass was prepared in the same manner as in the preparation of the cyan pigment dispersion liquid except that the cyan pigment was changed to the magenta pigment.

### <Preparation of Cyan Ink>

The cyan pigment dispersion liquid thus prepared, styrene-acrylate copolymers (molecular weight: 50000, acid number: 1.30, average particle diameter: 75 nm) as resin emulsion (fixing resin), organic solvents shown in Table I below, surfactants (MEGAFACE F 444 (manufactured by DIC Corporation)), and ion-exchanged waters were added with stirring. The obtained mixed solution was filtered through a filter with 1μm to obtain each cyan ink of Examples 1-14 and Comparative Examples 1-3.

### <Preparation of Magenta Ink>

Magenta ink of Examples 1-14 and Comparative Examples 1-3 was prepared in the same manner as the cyan ink except that the cyan pigment dispersion liquid was replaced with the magenta pigment dispersion liquid.

In the item of “pigment dispersion liquid” described in Table I, “cyan/magenta” represents parts by mass of “cyan pigment dispersion liquid” in the case of preparing the cyan ink. When the magenta ink is prepared, the amount represents parts by mass of the “magenta pigment dispersion liquid”.

### [Recording Method]

Each of the prepared inks was printed under the following printing conditions, and then subjected to a drying step to form an image. As the recording medium, a recording medium described in each evaluation method shown below was used, and as the ink, a cyan or magenta ink described below was used to form an image.

### (Printing Conditions, etc.)

Inkjet head: inkjet printer Samba G3L (manufactured by FUJIFILM DIMATIX, Inc.)
Droplet amount: A waveform and a voltage were set, driving was performed by any one of 1dpd (drop per dot)/2dpd/3dpd driving methods, and adjustment was performed so that a volume per droplet became a droplet amount described in the following Table II.

The droplet amount was measured by selecting 1000 nozzles at the center of the Samba G3L, ejecting 5000 shots from each nozzle, and measuring the weight with a balance.
droplet amount=measured weight/(number of nozzles×number of ejections×ink specific gravity)

Measured weight, the image of the 1000 pixel×5000 pixel was printed and immediately weighed without performing a drying step after printing. Then, a value obtained by subtracting the weight of the sheet before printing from the measured value was defined as the “measured weight”.

Number of nozzles, number of ejections; here, the number of nozzles is 1000, and the number of ejections is 5000.

Conveyance speed of the recording medium: the conveyance speed of the recording medium was adjusted to the conveyance speed shown in Table II below.
Circulation of ink: In the case of circulating the ink, as shown in FIG. 11, the pressures by the liquid feed pumps 88 and 89 were controlled, and the ink was circulated in the ink channel 84 at 20 mL/min. Note that in the following Table II, the case where the ink is not circulated is denoted by “a”, and the case where the ink is circulated is denoted by “b”.
Coating of pre-coat liquid: A pre-coat liquid shown below was coated on a recording medium with a bar coater using a wire bar No. 1 so that the coating film thickness became 1 μm, and dried with a drier for 10 seconds. Note that in the following Table II, the case of not applying a pre-coat liquid is denoted as “a”. In a case where the pre-coat liquid was applied, a case where the concentration of the resin to be added in the pre-coat liquid was 0.5% by mass was indicated as “b”, a case where the concentration was 1.0% by mass was indicated as “c”, and a case where the concentration was 2.0% by mass was indicated as “d”.

### <<Preparation of Pre-coat Liquid>>

The resin and the organic solvent were mixed while stirring so that the content of the resin was 0.5% by mass, 1.0% by mass, or 2.0% by mass, and the obtained mixed liquid was filtered through a 1-μm filter to prepare each pre-coat liquid.

### (Resin)

Urethane resin emulsion (manufactured by Taisei Fine Chemical Co., Ltd., WEN505c): 0.5% by mass/1.0% by mass/2.0% by mass

### (Organic Solvent)

Propylene glycol: 20% by mass

### (Surfactant)

Polyether siloxane copolymer (TEGO (registered trademark) WET-250, manufactured by Evonik Industries): 0.5% by mass
Drying step

As shown in FIG. 1, the nichrome wire as the thermal conduction type heating means (first dryer 240) installed on the lower surface of the conveyance belt 221 was energized to transmit heat to the back surface of the recording medium on the conveyance belt 221. Thereafter, the air in the drying furnace 251 heated by the energization of the second nichrome wire 252 which is the convection type heating means (second dryer 250) was convected by the first to third axial flow fans 254 to 256 and the cross flow fan 253, and the warm air was blown to the surface of the recording medium. The ink applied to the recording medium in this manner was dried. The drying time (the time required for the recording medium to pass through the first dryer and the second dryer) was 1 second. Furthermore, the surface temperature of the conveyance belt 221energized by the first dryer 240 was 60° C., and the temperature of the warm air blown by the first to third axial flow fans 254 to 256 that are the second dryer 250 was 100° C.

### [Evaluation]

### <Measurement of Dot Diameter>

As the recording medium, OK Top Coat (127.9 g/m 2 manufactured by Oji Paper Co., Ltd.) was used. As the inkjet head, Samba G3L (manufactured by FUJIFILM DIMATIX, Inc.) was used. Then, an image with 5% duty of the cyan ink was printed under the above-described printing conditions, and the dot diameter was measured.

Specifically, in an image in a completely dried state (a state in which the amount of moisture in the ink was reduced by 90% or more), arbitrary dot diameters at 100 points were measured using a handy image analyzer, and the average value thereof was calculated. As the handy image analyzer, PIAS-II (manufactured by QEA) was used.

### <Dot Enlargement Rate>

From the calculated dot diameter and the ink droplet diameter calculated by the following calculation method, a dot enlargement rate was calculated by the following equation.

dot enlargement rate=dot diameter (μm)/ink droplet diameter (μm)

The diameter of the ink droplet was calculated by converting the volume of one ink droplet into the volume of a sphere.

### <Minimum Dot Diameter>

The minimum dot diameter among the 100 random dot diameters measured above is shown in Table II below.

### <Drying Properties>

As the recording medium, OK Top Coat Mat N (127.9 g/m 2 manufactured by Oji Paper Co., Ltd.) was used.

In addition, solid printing was performed using a cyan ink at a duty of 100%, the OK Top Coat Mat was overlaid on the printed material that had undergone the drying step, the resultant was rubbed with a finger under a load of about 1 to 3 N, and the image drying properties were evaluated based on the following standards. AAA, AA, and A were determined as passing.

### (Standards)

AAA: No color transfer was observed under the load of 3 N.

AA: The color transfer was slightly observed under the load of 3 N.

A: The color transfer is not recognized under the load of IN, but the color transfer is recognized under the load of 3 N.

B: The color transfer is recognized under the load of 1 N.

### <Sheet Deformation Prevention Properties (Resistance)>

As the recording medium, OK Top Coat Mat N (127.9 g/m 2 manufactured by Oji Paper Co., Ltd.) was used. A solid image was formed with a cyan ink at a duty of 100% and stored under constant conditions of 23° C. and 50% RH for 24 hours.

The sheet deformation prevention properties were evaluated based on the following standards. AAA, AA, and A were determined as passing.

### (Standards)

AAA: The rise of the end portion of the sheet is on average less than 4 mm.

AA: The rise of the end portion of the sheet is on average equal to or more than 4 mm and less than 7 mm.

A: The rise of the end portion of the sheet is on average equal to or more than 7 mm and less than 10 mm.

B: The rise of the end portion of the sheet is on average equal to or more than the 10 mm, or the center of the sheet surface has a convex shape equal to or greater than 7 mm in an arch shape.

### <Ink Penetrating Prevention Properties (Resistance)>

As the recording medium, OK Prince (52g/m2 , manufactured by Oji Paper Co., Ltd.) was used.

In addition, solid printing with 100% duty of cyan ink was performed, and the value of L*was measured on the back surface of the printed matter subjected to the drying step using a fluorescence spectrodensitometer FD7 (manufactured by Konica Minolta Co., Ltd), and ink penetrating was evaluated according to the following standards AAA, AA, and A were determined as passing.

### (Standards)

AAA: L*is equal to or greater than 86.

AA: L*is equal to or greater than 84 and less than 86.

A: L*is equal to or greater than 82 and less than 84.

B: L*is less than 82.

### <Color Bleeding Prevention Properties (Resistance)>

As the recording medium, OK Top Coat Mat N (127.9 g/m 2 manufactured by Oji Paper Co., Ltd.) was used.

In addition, solid printing was performed with 100% duty of the magenta ink, an image was formed on the solid printing so as to have a line width of 0.4 mm in cyan, and the color bleeding was evaluated according to the following standards with respect to the printed matter subjected to the drying step. AAA, AA, and A were determined as passing.

### (Standards)

AAA: The bleeding is smaller than 0.02 mm.

AA: The bleeding is larger than 0.02 mm and smaller than 0.05 mm.

A: The bleeding is larger than 0.05 mm and smaller than 0.1 mm.

B: The bleeding is greater than 0.1 mm.

### <Color Gamut>

As the recording medium, OK Top Coat+(127.9 g/m 2 manufactured by Oji Paper Co., Ltd.) was used.

Printing was performed with the cyan ink at a duty of 10 to 100% in increments of 10% duty, and the back surface of the printed product having undergone the drying step was measured using a fluorescence spectroscopic densitometer FD7 (manufactured by Konica Minolta, Inc). The hue angle h was calculated, and the color gamut was evaluated according to the following standards AAA, AA, and A were determined as passing.

### (Standards)

AAA: The hue angle h is 60° or more.

AA: The hue angle h is 55° or more and less than 60°.

A: The hue angle his 50° or more and less than 55°.

B: The hue angle his less than 50°.

### <Graininess>

As the recording medium, OK Top Coat+(127.9 g/m 2 manufactured by Oji Paper Co., Ltd.) was used.

Printing was performed with the cyan ink at a duty of 10 to 50% in increments of 10% duty, and the printed product subjected to the drying step were evaluated for graininess according to the following standards AA and A were determined as passing.

### (Standards)

AA: No roughness is visible.

A: The roughness is slightly visible.

B: The roughness is clearly visible.

### <Ejection Stability>

OK Top Coat+(127.9 g/m 2, manufactured by Oji Paper Co., Ltd.) was used as the recording medium, and 100 dots were printed using the inkjet head (Samba G3L (manufactured by FUJIFILM DIMATIX, Inc.)).

Thereafter, the dots after leaving for 5 minutes without ejecting were observed, the number of dots at this time was calculated, and the ejection rate was calculated by the following equation.

ejection rate=number of dots after leaving for 5 minutes/number of dots without leaving

(note that the “number of dots without leaving” is 100 here)

The ejection stability was evaluated according to the following standards. AAA, AA, and A were determined as passing.

### (Standards)

AAA: The ejection rate is 90% or more

AA: The ejection rate is 70% or more and less than 90%

A: The ejection rate is 50% or more and less than 70%

TABLE I

| | | | EXAM- | EXAM- | EXAM- | EXAM- | EXAM- | EXAM- | EXAM- | EXAM- | EXAM- |
|---|---|---|---|---|---|---|---|---|---|---|---|
| | | | PLE 1 | PLE 2 | PLE 3 | PLE 4 | PLE 5 | PLE 6 | PLE 7 | PLE 8 | PLE 9 |
| INK | PIGMENT | CYAN/ | 5.0 | 5.0 | 5.0 | 5.0 | 5.0 | 5.0 | 7.0 | 10.0 | 10.0 |
| [PARTS | DISPERSION | MAGENTA | | | | | | | | | |
| BY | LIQUID | | | | | | | | | | |
| MASS] | DISPERSING | BYK190 | 1.0 | 1.0 | 1.0 | 1.0 | 1.0 | 1.0 | 1.4 | 2.0 | 2.0 |
| | AGENT | | | | | | | | | | |
| | ORGANIC | PROPYLENE | 15.0 | 15.0 | 15.0 | 15.0 | 10.0 | 10.0 | 10.0 | 10.0 | 10.0 |
| | SOLVENT | GLYCOL | | | | | | | | | |
| | | 1,2- | 10.0 | 10.0 | 10.0 | 0.0 | 0.0 | 0.0 | 0.0 | 0.0 | 0.0 |
| | | BUTANEDIOL | | | | | | | | | |
| | | 1,2- | 10.0 | 10.0 | 10.0 | 10.0 | 10.0 | 10.0 | 10.0 | 10.0 | 10.0 |
| | | HEXANEDIOL | | | | | | | | | |
| | FIXING | STYRENE/ | 3.0 | 3.0 | 3.0 | 3.0 | 3.0 | 3.0 | 3.0 | 3.0 | 3.0 |
| | RESIN | ACRYLIC ACID | | | | | | | | | |
| | | COPOLYMER | | | | | | | | | |
| | SURFACTANT | MEGAFACE | 0.3 | 0.3 | 0.3 | 0.3 | 0.3 | 0.3 | 0.3 | 0.3 | 0.3 |
| | | F-444 | | | | | | | | | |

| | | | | | | | | | |
|---|---|---|---|---|---|---|---|---|---|
| WATER | 55.7 | 55.7 | 55.7 | 65.7 | 70.7 | 70.7 | 68.3 | 64.7 | 64.7 |
| TOTAL PARTS BY MASS | 100.0 | 100.0 | 100.0 | 100.0 | 100.0 | 100.0 | 100.0 | 100.0 | 100.0 |
| OF INKJET INK | | | | | | | | | |
| TOTAL ORGANIC SOLVENT | 35.0 | 35.0 | 35.0 | 25.0 | 20.0 | 20.0 | 20.0 | 20.0 | 20.0 |
| AMOUNT | | | | | | | | | |

| | | | | | | | | COMPAR- | COMPAR- | COMPAR- |
|---|---|---|---|---|---|---|---|---|---|---|
| | | | | | | | | ATIVE | ATIVE | ATIVE |
| | | | EXAM- | EXAM- | EXAM- | EXAM- | EXAM- | EXAM- | EXAM- | EXAM- |
| | | | PLE 10 | PLE 11 | PLE 12 | PLE 13 | PLE 14 | PLE 1 | PLE 2 | PLE 3 |
| INK | PIGMENT | CYAN/ | 10.0 | 10.0 | 10.0 | 10.0 | 10.0 | 4.0 | 3.0 | 3.0 |
| [PARTS | DISPERSION | MAGENTA | | | | | | | | |
| BY | LIQUID | | | | | | | | | |
| MASS] | DISPERSING | BYK190 | 2.0 | 2.0 | 2.0 | 2.0 | 2.0 | 0.8 | 0.6 | 0.6 |
| | AGENT | | | | | | | | | |
| | ORGANIC | PROPYLENE | 10.0 | 10.0 | 10.0 | 10.0 | 10.0 | 10.0 | 10.0 | 10.0 |
| | SOLVENT | GLYCOL | | | | | | | | |
| | | 1,2- | 0.0 | 0.0 | 0.0 | 0.0 | 0.0 | 0.0 | 0.0 | 0.0 |
| | | BUTANEDIOL | | | | | | | | |
| | | 1,2- | 10.0 | 10.0 | 10.0 | 10.0 | 10.0 | 10.0 | 10.0 | 10.0 |
| | | HEXANEDIOL | | | | | | | | |
| | FIXING | STYRENE/ | 3.0 | 3.0 | 3.0 | 3.0 | 3.0 | 3.0 | 3.0 | 3.0 |
| | RESIN | ACRYLIC ACID | | | | | | | | |
| | | COPOLYMER | | | | | | | | |
| | SURFACTANT | MEGAFACE | 0.3 | 0.3 | 0.3 | 0.3 | 0.3 | 0.3 | 0.3 | 0.3 |
| | | F-444 | | | | | | | | |

| | | | | | | | | |
|---|---|---|---|---|---|---|---|---|
| WATER | 64.7 | 64.7 | 64.7 | 64.7 | 64.7 | 71.9 | 73.1 | 73.1 |
| TOTAL PARTS BY MASS | 100.0 | 100.0 | 100.0 | 100.0 | 100.0 | 100.0 | 100.0 | 100.0 |
| OF INKJET INK | | | | | | | | |
| TOTAL ORGANIC SOLVENT | 20.0 | 20.0 | 20.0 | 20.0 | 20.0 | 20.0 | 20.0 | 20.0 |
| AMOUNT | | | | | | | | |

TABLE II

| | | EXAM- | EXAM- | EXAM- | EXAM- | EXAM- | EXAM- | EXAM- | EXAM- | EXAM- |
|---|---|---|---|---|---|---|---|---|---|---|
| | | PLE 1 | PLE 2 | PLE 3 | PLE 4 | PLE 5 | PLE 6 | PLE 7 | PLE 8 | PLE 9 |
| PRINTING | DROPLET | 3.0 | 3.0 | 3.0 | 3.0 | 3.0 | 3.0 | 3.0 | 3.0 | 3.0 |
| CONDITIONS | AMOUNT [pL] | | | | | | | | | |
| | CONVEYANCE | 500 | 800 | 1200 | 1200 | 1200 | 1200 | 1200 | 1200 | 1200 |
| | SPEED [mm/s] | | | | | | | | | |
| | INK | a | a | a | a | a | b | b | b | b |
| | CIRCULATION | | | | | | | | | |
| | APPLICATION | a | a | a | a | a | a | a | a | b |
| | OF PRE-COAT | | | | | | | | | |
| | LIQUID | | | | | | | | | |
| EVALUATION | MINIMUM DOT | 42 | 42 | 42 | 40 | 40 | 40 | 32 | 32 | 40 |
| RESULT | DIAMETER | | | | | | | | | |
| | [μm] | | | | | | | | | |
| | DOT | 2.3 | 2.3 | 2.3 | 2.2 | 2.2 | 2.2 | 1.8 | 1.8 | 2.2 |
| | ENLARGEMENT | | | | | | | | | |
| | RATE [TIMES] | | | | | | | | | |
| | DRYING | AA | AA | A | AA | AA | AA | AA | AA | AA |
| | PROPERTIES | | | | | | | | | |
| | SHEET | A | A | A | A | AA | AA | AA | AA | AA |
| | DEFORMATION | | | | | | | | | |
| | PREVENTION | | | | | | | | | |
| | PROPERTIES | | | | | | | | | |
| | INK | A | A | A | A | A | A | AA | AA | AA |
| | PENETRATING | | | | | | | | | |
| | PREVENTION | | | | | | | | | |
| | PROPERTIES | | | | | | | | | |
| | COLOR | AA | A | A | A | A | A | A | AA | AA |
| | BLEEDING | | | | | | | | | |
| | PREVENTION | | | | | | | | | |
| | PROPERTIES | | | | | | | | | |
| | COLOR | A | A | A | A | A | A | A | A | AA |
| | GAMUT | | | | | | | | | |
| | GRAININESS | AA | AA | AA | AA | AA | AA | AA | AA | AA |
| | EJECTION | AA | AA | AA | AA | A | AAA | AAA | AAA | AAA |
| | STABILITY | | | | | | | | | |

| | | | | | | | COMPAR- | COMPAR- | COMPAR- |
|---|---|---|---|---|---|---|---|---|---|
| | | | | | | | ATIVE | ATIVE | ATIVE |
| | | EXAM- | EXAM- | EXAM- | EXAM- | EXAM- | EXAM- | EXAM- | EXAM- |
| | | PLE 10 | PLE 11 | PLE 12 | PLE 13 | PLE 14 | PLE 1 | PLE 2 | PLE 3 |
| PRINTING | DROPLET | 3.0 | 3.0 | 2.5 | 2.0 | 1.5 | 3.0 | 3.0 | 5.0 |
| CONDITIONS | AMOUNT [pL] | | | | | | | | |
| | CONVEYANCE | 1200 | 1200 | 1200 | 1200 | 1200 | 1200 | 1200 | 1200 |
| | SPEED [mm/s] | | | | | | | | |
| | INK | b | b | b | b | b | b | b | b |
| | CIRCULATION | | | | | | | | |
| | APPLICATION | c | d | c | c | c | a | a | a |
| | OF PRE-COAT | | | | | | | | |
| | LIQUID | | | | | | | | |
| EVALUATION | MINIMUM DOT | 44 | 54 | 40 | 40 | 35 | 40 | 42 | 50 |
| RESULT | DIAMETER | | | | | | | | |
| | [μm] | | | | | | | | |
| | DOT | 2.5 | 3.0 | 2.4 | 2.6 | 2.5 | 2.2 | 2.3 | 2.4 |
| | ENLARGEMENT | | | | | | | | |
| | RATE [TIMES] | | | | | | | | |
| | DRYING | AA | AA | AA | AA | AAA | A | B | B |
| | PROPERTIES | | | | | | | | |
| | SHEET | AA | AA | AA | AA | AAA | B | B | B |
| | DEFORMATION | | | | | | | | |
| | PREVENTION | | | | | | | | |
| | PROPERTIES | | | | | | | | |
| | INK | AA | AAA | AAA | AAA | AAA | A | B | B |
| | PENETRATING | | | | | | | | |
| | PREVENTION | | | | | | | | |
| | PROPERTIES | | | | | | | | |
| | COLOR | AA | AAA | AAA | AAA | AAA | A | B | B |
| | BLEEDING | | | | | | | | |
| | PREVENTION | | | | | | | | |
| | PROPERTIES | | | | | | | | |
| | COLOR | AAA | AAA | AAA | AAA | AAA | A | AA | AAA |
| | GAMUT | | | | | | | | |
| | GRAININESS | AA | A | AA | AA | AA | AA | AA | B |
| | EJECTION | AAA | AAA | AAA | AA | AA | AAA | AAA | AAA |
| | STABILITY | | | | | | | | |

As shown in the above results, according to the recording method of the present invention, compared to the recording methods of the Comparative Examples, the drying properties are excellent, and sheet deformation, ink penetrating, and color bleeding can be prevented.

In addition, it can be seen that the color gamut, graininess, and ejection stability are also excellent.

By the above-described means of the present invention, it is possible to provide a recording method and a recording system in which the drying efficiency of a water-based ink is improved in high-speed conveyance, sheet deformation, ink penetrating, and color bleeding are prevented, and the color gamut and graininess are excellent.

An expression mechanism or an action mechanism of the effects of the present invention is not clear, but is assumed as follows.

In the inkjet recording method of the present invention, when the recording-medium conveyance speed is high speed conveyance of 500 mm/s or more, the pigment content of the water-based inkjet ink is set to 5% by mass or more relative to the total amount of the ink, and the volume of one ink droplet is set to 3 pL or less. That is, according to the present invention, a water-based inkjet ink having a high pigment concentration is ejected in the form of small droplets, whereby the ink can be dried in a short period of time, the sheet deformation can be prevented, and the drying efficiency is excellent.

In addition, since the pigment concentration in one droplet of the ink is high, the color gamut is expanded, the coloring properties is good, and the graininess of the ink is good. Further, ink penetrating and color bleeding can also be prevented.

In particular, in the present invention, the dot enlargement rate of one droplet of the inkjet ink landed on the recording medium is set in a range of 2.2 to 3.5 times. Thus, by wetting and spreading a dot of one droplet to form a thin film, the drying time can be further shortened, and also the expansion of the color gamut and the graininess of the ink become more satisfactory.

Although embodiments of the present invention have been described and illustrated in detail, the disclosed embodiments are made for purposes of illustration and example only and not limitation. The scope of the present invention should be interpreted by terms of the appended claims

1. A recording method comprising:
conveying a recording medium; and
performing recording by ejecting droplets of an inkjet ink onto the recording medium while conveying the recording medium, wherein,
a conveyance speed of the recording medium is 500 mm/s or more,
the inkjet ink contains at least water and a pigment,
the content of the pigment is 5% by mass or more with respect to a total amount of the inkjet ink, and one droplet of the inkjet ink has a volume of 3 pL or less.

2. The recording method according to claim 1, wherein a dot enlargement rate of one droplet of the inkjet ink landed on the recording medium is within a range of 2.2 to 3.5 times.

3. The recording method according to claim 1, wherein the droplets are ejected while the inkjet ink is circulated by an ink circulator.

4. The recording method according to claim 1, wherein the inkjet ink further contains an organic solvent, and a content of the organic solvent is in a range of 0.1 to 25% by mass with respect to the total amount of the inkjet ink.

5. The recording method according to claim 1, wherein the content of the water is 40% by mass or more with respect to the total amount of the inkjet ink.

6. The recording method according to claim 1, wherein a volume of one droplet of the inkjet ink is within a range of 1 to 2 pL.

7. The recording method according to claim 1, wherein a conveyance speed of the recording medium is 1000 mm/s or more.

8. The recording method according to claim 1, wherein a minimum dot diameter of one droplet of the inkjet ink landed on the recording medium is 45 μm or less.

9. The recording method according to claim 1, wherein drying time until 80% by mass or more of the inkjet ink landed on the recording medium is evaporated is 1 second or less.

10. The recording method according to claim 1, wherein the recording medium is conveyed in a flat sheet-fed manner.

11. A recording system comprising:
a conveyor that conveys a recording medium; and
an inkjet ink ejector that performs recording by ejecting a droplet of an inkjet ink onto the recording medium while conveying the recording medium,
wherein,
a conveyance speed of the recording medium is 500 mm/s or more,
the inkjet ink contains at least water and a pigment,
the content of the pigment is 5% by mass or more with respect to a total amount of the inkjet ink, and
one droplet of the inkjet ink has a volume of 3 pL or less.
